(19) United States
(12) Patent Application Publication
(10) Pub. No.: US 2009/0150476 A1
(43) Pub. Date: Jun. 11, 2009

(54) System and Method for Transmitting Content From a Network Device to a Target Device

(75) Inventors: Koen Hendrik Johan Vrielink, Eindhoven (NL); Lukasz Szostek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,322

(22) PCT Filed: Nov. 9, 2005
(86) PCT No.: PCT/IB2005/053685

§ 371 Date: May 15, 2007

(30) Foreign Application Priority Data
Nov. 15, 2004 (EP) 04105754.8

(51) Int. Cl. G06F 15/16

(52) U.S. Cl. 709/203

(57) ABSTRACT

The invention relates to a method and a device for transmitting content, selected by a user at a network device, from the network device to a target device, wherein the user has user account data stored at the network device identified by a user account ID, and wherein the user account data at least comprises a network address of the target device, in which the user ID is received from the user for referring to the user account data and, based thereon, the content is transmitted to the target device on the basis of the network address.

The invention relates to a method for transmitting content, selected by a user at a network device, from said network device to a target device, wherein said user has user account data stored at said network device identified by a user account ID, and wherein said user account data at least comprises a network address of said target device.

The invention also relates to a network device for transmitting content selected by a user from said network device to a target device, wherein said user has user account data stored at said network device identified by a user account ID, and wherein said user account data at least comprises a network address of said target device.

The invention further relates to a network system comprising a network device and at least one target device, wherein the network device transmits content selected by a user from said network device to said at least one target device, wherein said user has user account data stored at said network device identified by a user account ID, and wherein said user account data at least comprises a network address of said target device.

Broadband always-on internet connections can enable users to shop for content on-line, using any internet-capable device at any location, and to have this content delivered to an always-on and always-connected storage device at home. This means that they can, for instance, use their iMode-enabled mobile phone to browse some on-line shops and make purchases and have the content waiting for them at home when they get there. Use of a different device for shopping than for content delivery may have the following reasons. The shopping device is resource-constrained, or is not broadband-connected or not compliant with an acceptable content protection system. Since the device that is used for browsing is not the device where the content is delivered, one of the problems with such systems is that the users must somehow specify the target device. Furthermore, before any purchase is made, they want to make sure that the shop is in fact able to connect to this target device and deliver the content.

It is therefore an object of the invention to provide a solution to the above-mentioned problems.

According to one aspect, the invention relates to a method for transmitting content, selected by a user at a network device, from said network device to a target device, wherein said user has user account data stored at said network device identified by a user account ID, and wherein said user account data at least comprises a network address of said target device, the method comprising the steps of:

receiving said user ID from said user referring to said user account data, and

transmitting said selected content to said target device on the basis of said network address comprised in said user account data.

The user can thus refer in an easy and user-friendly way to the target ID after selecting content, with the result that the target device is uniquely identified by the network device when transmitting the content.

In one embodiment, the content delivery protocol of said target device is further comprised in said user account data. The network device can thereby adapt its transmitting protocol to the content delivery protocol of the target device.

In another embodiment, the user account data are obtained by initiating a connection between said target device and said network device and transmitting said account data to said network device. It is thereby prevented that a third agent, which is not uniquely identified by the target device, can send content to this target device, so that safety against e.g. viruses is ensured. Moreover, the account data is provided to the network device in a user-friendly way via the target device.

In a further embodiment, the network device sends a request to the target device prior to transmitting said selected content requesting for the content delivery protocol of said target device. A dynamical way of transmitting content to the target device is obtained in this way, in which the content can be adapted to e.g. more than one target device where each target device is requested for its content delivery protocol prior to sending.

In a further embodiment, the target device regularly checks whether content has been requested by said user and, based thereon, initiates the transmission of said content. The transmission of the content is thus controlled or initiated by the target device.

The invention also relates to a computer-readable medium having instructions stored therein for causing a processing unit to execute a method as described above.

According to another aspect, the present invention relates to a network device for transmitting content selected by a user from said network device to a target device, wherein said user has user account data stored at said network device identified by a user account ID, and wherein said user account data at least comprises a network address of said target device, the network device comprising:

means for receiving said user ID from said user referring to said user account data, and

means for transmitting said selected content to said target device on the basis of said network address comprised in said user account data.

According to another aspect, the present invention relates to a network system comprising a network device and at least one target device, wherein the network device transmits content selected by a user from said network device to said at least one target device, wherein said user has user account data stored at said network device identified by a user account ID, and wherein said user account data at least comprises a network address of said at least one target device, the network system comprising:

means for using said user ID from said user referring to said user account data, and

means for transmitting said selected content to said at least one target device on the basis of said network address comprised in said user account data.

In one embodiment, said user account data is obtained by initiating a connection between the target device and the network device and transmitting the network address to said network device.

In another embodiment, a web server is used for initiating said connection between said at least one target device and said network device. In doing so, a user can e.g. easily create the account address.

In one embodiment, said web server is integrated into said at least one target device. In another embodiment, said web server is situated externally of said target device. In the former case, the web server and the target device may be a PC computer, with the user providing the account data to the network device, using a single device. In the latter case, the user target device may act as a web server which the user accesses when providing the account data.

In another embodiment, said network device is compatible with various target devices. In this way, a user can provide the network device with several account data for several target devices which might adapt various content delivery protocols.

In a further embodiment, said at least one target device is a polling device. The target device can thus regularly check whether a new content has been requested or purchased.

Preferred embodiments of the invention will be described hereinafter with reference to the Figures, in which

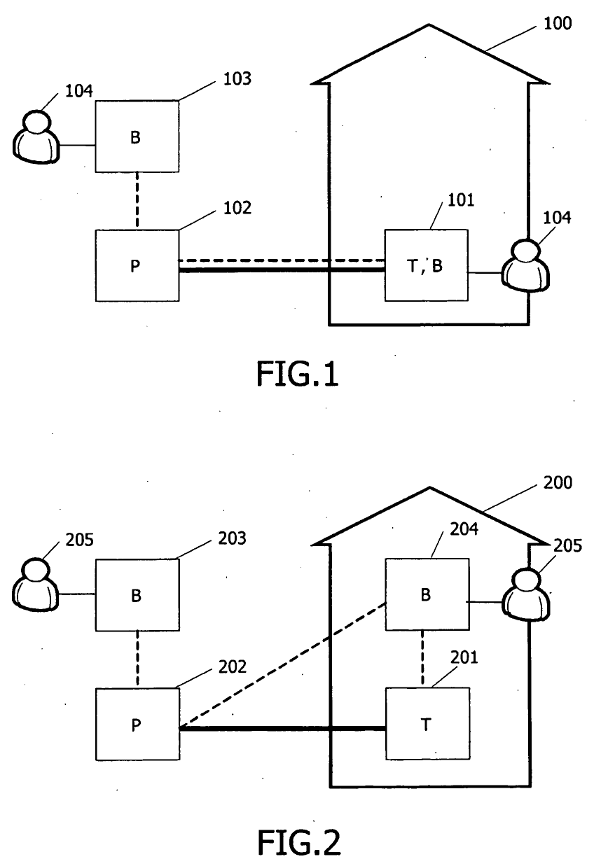

FIG. 1 illustrates a system according to the invention, comprising a target device with an integrated web browser and a network device;

FIG. 2 shows another embodiment of the invention, in which the target device and the browser are two separate devices, and

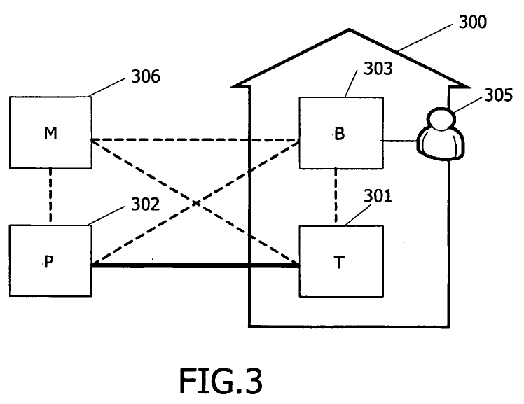

FIG. 3 shows a further embodiment of the invention, wherein a target device is controlled through an interface.

FIG. 1 illustrates a system according to the invention, comprising a target device 101 with an integrated web browser and a network device 102, wherein the target device 101 is uniquely identified by the network device 102 by a user account data stored at the network device 102, which at least comprises the network address, e.g. the IP address, of the target device 101. In a preferred embodiment, the user account data further comprises the content delivery protocol of the target device (or devices) which enables the network device 102 to be compatible with the target device. Of course, the user account at the network device 102 may comprise more than one content delivery protocol for various target devices and adapt the transmitted content to the content delivery protocols used by the target devices.

The network device 101 and those (202, 302) referred to in the embodiments in FIGS. 2 and 3 are provided with a memory for e.g. storing said user account data, a processor for e.g. referring to the user account data, a receiver for e.g. receiving external requests from user or target devices 101 and a transmitter for transmitting content from the network device 102 to the target device 101.

In the embodiment in FIG. 1, the target device 101 and the integrated web browser are located at the user's home 100, whence the user account data is sent to the network device 102. This may be done by accessing the network device 102 from the web browser 101, thereby initiating a connection between the target device 101 and the network device 102. Subsequently, the user 104 may e.g. be requested to state the user account ID, and the network address of the target device, e.g. the IP address. Additionally, the user may provide the billing address (e.g. the credit card number), the user name and other detailed information about the user 104, etc. The user account ID may be adapted to make it easier for the user 104 to refer to this account, when the user works externally with the network device 102. This may be done by using any kind of portable web browser 103, e.g. WAP, iMode and the like. In doing so, the user 104 can e.g. purchase content at the target device 102, which may be e.g. a content shop selling digital content, e.g. a movie, music, etc, by referring to the user account data for the target device 101 using the user account ID. In one embodiment, the target device 101 checks regularly at the network device whether or not content has been requested or purchased. If so, the target device 101 initiates the transmission of the content from the network device 102 to the target device 101. In another embodiment, the network device 102 automatically sends the content to the target device 101 as soon as it has been purchased and billed. Since the content delivery protocol of the target device 101 may also be given in the account data, the network device 102 adapts the transmitting protocol (e.g. mbf) to said content delivery protocol used by the target device 101.

In one embodiment, the network device 102 requests the target device 101 about the content delivery protocol for the target device 101. In this embodiment, the target device 101 is adapted to respond to this request and, based on the response, the network device 102 adapts the transmitting protocol to the content delivery protocol.

Of course the user's home 100 may be provided with various target devices having various account addresses stored in the account data at the network device 102. The user 104 can thus purchase various types of content, e.g. music or movies, wherein each content delivery can be adapted for various target devices.

Alternatively, the user's home 100 may be provided with various target devices having the same account addresses at the network device 102. The user 104 can thus purchase various types of content, e.g. music or movies, wherein each content delivery can be adapted for various target devices (e.g. some may be able to handle video, some audio). In one embodiment, the network device 102 sends the content to all target devices which are turned on. Those target devices which are adapted to receive such content will receive it and e.g. store it, other devices which are not adapted to receive such content might respond accordingly, i.e. indicating that this content is not intended for them.

In another embodiment, the account data is sent to the network device 102 externally from the user's home 100, by using any kind of web browser to connect to the target device 101, and the above-mentioned steps are subsequently performed to provide the user account data at 102 via 101. This would be the initial step in the case the user has not provided said account data to the network device 102. For example, the user may be on a train on his way home and, by using his mobile phone, can both create an account address and subsequently order a video movie to watch when he comes home.

In a further embodiment, the account data is provided and said one or more target devices 101 are coupled to the account at a later time, e.g. when content is to be sent to these target devices for the first time.

In a further embodiment, the target device 101 is authenticated to the network device 101 through cryptographic means like a secure authenticated channel. This SAC could be based on a shared secret or public/private key-pair exchanged upon registration of the target device at the network device.

FIG. 2 shows another embodiment of the present invention, in which the target device 201 and the browser 204 are two separate devices. In this embodiment, the target device 201 acts as a web server which the user 205 will access within his home 200, using any kind of web browser 204, such as PC Computer, iPronto or PDA, or outside his home (not shown). The user 205 may then be presented with a web page, on which he may enter a Uniform Resource Locator (URL) of the network shop at the network device 202 he intends to visit. For example, the target device 201 will use the URL to connect to the shop and verify that the shop has a content delivery mechanism, which is compatible with the target device 201. If so, the target will fetch account-setup web pages from the shop, integrate these with its own web pages and in this way allow the user 205 to set up an account at the shop and send the user account data. This step is of course applicable to the embodiment described with reference to FIG. 1. After the account data has been provided, the user 205 is able to use any browser device, e.g. iMode, WAP, to surf to the shop, log-in and make purchases. Independently, the target device 201 makes sure that the content delivery is initiated through regular checking as described with reference to FIG. 1, or the network device 202 may automatically transmit the content to the target device 201.

FIG. 3 shows another embodiment of the present invention, wherein a target device 301 is controlled through an interface, preferably a proprietary interface, by e.g. a manufacturer who may have a website which a user 305 could use to provide the user account data at a network device 302 in a way as previously described with reference to FIGS. 1 and 2.

The target devices described with reference to FIGS. 1 to 3 may be polling devices. Alternatively, the target device may be triggered to check for and initiate content transfers from 102. These triggers may be commands from another device via the home network, the Internet, SMS/MMS or other mechanisms. The embodiments described with reference to FIGS. 1 to 3 may of course easily be combined.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb ‘comprise’ and its conjugations does not exclude the presence of elements or steps other than those stated in a claim. The invention can be implemented by means of hardware comprising several distinct elements and by means of a suitably programmed computer. In a device claim enumerating several means, several of these means can be embodied by one and the same item of hardware. The mere fact that certain measures are recited in mutually different, dependent claims does not indicate that a combination of these measures cannot be used to advantage.

1. A method for transmitting content, selected by a user at a network device, from said network device to a target device, wherein said user has user account data stored at said network device identified by a user account ID, and wherein said user account data at least comprises a network address of said target device, the method comprising the steps of:
receiving said user ID from said user referring to said user account data, and
transmitting said selected content to said target device on the basis of said network address comprised in said user account data.

2. A method according to claim 1, wherein the content delivery protocol of said target device is further comprised in said user account data.

3. A method according to claim 1, wherein said user account data is obtained by initiating a connection between said target device and said network device and transmitting said account data to said network device.

4. A method according to claim 1, wherein said network device sends a request to the target device prior to transmitting said selected content requesting for the content delivery protocol of said target device.

5. A method according to claim 1, wherein said target device regularly checks whether content has been requested by said user and, based thereon, initiates the transmission of said content.

6. A computer-readable medium having instructions stored therein for causing a processing unit to execute the method of claim 1.

7. A network device for transmitting content selected by a user from said network device to a target device, wherein said user has user account data stored at said network device identified by a user account ID, and wherein said user account data at least comprises a network address of said target device, the network device comprising:
means for receiving said user ID from said user referring to said user account data, and
means for transmitting said selected content to said target device on the basis of said network address comprised in said user account data.

8. A network system comprising a network device and at least one target device, wherein the network device transmits content selected by a user from said network device to said at least one target device, wherein said user has user account data stored at said network device identified by a user account ID, and wherein said user account data at least comprises a network address of said at least one target device, the network system comprising:
means for using said user ID from said user referring to said user account data, and
means for transmitting said selected content to said at least one target device on the basis of said network address comprised in said user account data.

9. A network system according to claim 8, wherein said user account data is obtained by means of initiating a connection between said target device and said network device and transmitting said network address to said network device.

10. A network system according to claim 8, wherein a web server is used for initiating said connection between said at least one target device and said network device.

11. A network system according to claim 8, wherein said web server is integrated into said at least one target device.

12. A network system according to claim 8, wherein said web server is situated externally of said at least one target device.

13. A network system according to claim 8, wherein said network device is compatible with various target devices.

14. A network system according to claim 8, wherein said at least one target device is a polling device.
